(19) United States
(12) Patent Application Publication
(10) Pub. No.: US 2016/0312622 A1
(43) Pub. Date: Oct. 27, 2016

(54) THERMAL BARRIER COATING OF A TURBINE BLADE

(71) Applicant: SIEMENS AKTIENGESELLSCHAFT, München (DE)

(72) Inventors: Bernd Burbaum, Falkensee (DE); Torsten Neddemeyer, Falkensee (DE)

(73) Assignee: Siemens Aktiengesellschaft, Munich (DE)

(21) Appl. No.: 15/103,103

(22) PCT Filed: Nov. 28, 2014
(86) PCT No.: PCT/EP2014/075965

§ 371 Date: Jun. 9, 2016

(30) Foreign Application Priority Data
Dec. 13, 2013 (EP) 13197179.8

(51) Int. Cl. F01D 5/18; F01D 9/04; F01D 25/12; F01D 5/28

(52) U.S. Cl. CPC F01D 5/187; F01D 5/288; F01D 9/041; F01D 25/12; F05D 2220/32; F05D 2230/90; F05D 2260/202; F05D 2300/177

(57) ABSTRACT

A turbine blade or vane having a thermal barrier coating, the thermal barrier coating including an inner layer and an outer layer, which is arranged directly or indirectly on the inner layer, wherein the inner layer has flow ducts which are connected fluidically to one another and which are connected to a cooling fluid supply duct. The outer layer has flow ducts which are connected fluidically to one another and which are connected to a cooling fluid supply duct.

### CROSS REFERENCE TO RELATED APPLICATIONS

This application is the US National Stage of International Application No. PCT/EP2014/075965 filed Nov. 28, 2014, and claims the benefit thereof. The International Application claims the benefit of European Application No. EP13197179 filed Dec. 13, 2013. All of the applications are incorporated by reference herein in their entirety.

### FIELD OF THE INVENTION

The present invention relates to a turbine blade or vane, to a method for coating a turbine blade or vane, to a method for cooling a turbine blade or vane and to a turbine. Here, the focus is on the thermal barrier coating, the production thereof and the use thereof.

### BACKGROUND OF THE INVENTION

Turbine blades or vanes, which are exposed to high temperatures during the operation of a turbine, are typically coated with a thermal barrier coating (TBC). The turbine blades or vanes exposed to high temperatures, for example gas turbine blades or vanes or steam turbine blades or vanes, are typically produced from nickel-based superalloys.

During the operation of the turbine, the impact of foreign bodies can lead to spalling of the thermal barrier coating (TBC) from the nickel-based superalloy. If the thermal barrier coating (TBC) on the turbine blade or vane becomes damaged or is removed, this leads very quickly to failure of the turbine blade or vane.

U.S. Pat. No. 6,617,003 B1 describes a cooled thermal barrier coating system, in which the thermal barrier coating system is actively cooled by means of micro-ducts.

WO 2008/100306 A2 describes a turbine blade or vane made of a ceramic fiber composite material (CMC, Ceramic Matrix Composite), to which a ceramic thermal barrier coating is applied. Cooling-air ducts can be formed both in the fiber composite material, from which the turbine blade or vane is formed, and also in the ceramic thermal barrier coating.

WO 2006/069941 describes a method for producing a turbine blade or vane, in which a main body having ducts is produced and the ducts are then covered by applying a coating material to the main body.

US 2003/0209589 A1 describes a method for producing cooling ducts in a ceramic coating applied to a metallic substrate. To produce the ducts, firstly a material is applied to the surface of the metallic substrate, this material being removed again after the application of the coating material.

It is an object of the present invention to provide an advantageous turbine blade or vane, a method for coating the latter, an advantageous turbine and a method for cooling a turbine blade or vane.

### SUMMARY OF INVENTION

The aforementioned objects are achieved by a turbine blade or vane, a turbine, a method for coating a turbine blade or vane and a method for cooling a turbine blade or vane as claimed. The dependent claims contain further advantageous configurations of the invention.

The turbine blade or vane according to the invention comprises a thermal barrier coating. The thermal barrier coating comprises an inner layer and an outer layer. The outer layer is arranged directly or indirectly on the inner layer. The inner layer comprises flow ducts which are connected fluidically to one another. The flow ducts are connected to a cooling fluid supply duct. The outer layer likewise comprises flow ducts which are connected fluidically to one another and which are connected to a cooling fluid supply duct.

The outer layer here can be arranged directly on the inner layer. As an alternative thereto, a separating layer can be arranged between the inner layer and the outer layer. The separating layer has the advantage that independent operation of the cooling system of the inner layer and of the cooling system of the outer layer, or separate cooling of the inner layer and of the outer layer, is ensured and made possible.

Furthermore, the turbine blade or vane can comprise a blade or vane main body with an outer surface, wherein the inner layer is at a smaller distance from the outer surface of the blade or vane main body than the outer layer in the direction of the surface normals of the outer surface in the region of the coating.

The turbine blade or vane according to the invention has the advantage that it has a two-layer cooling system. The inner layer and the outer layer can be supplied with cooling fluid independently of one another and separately. If the outer layer becomes damaged by an impact, the cooling system of the blade or vane will be maintained by the inner, second system in the inner layer. This achieves an increase in performance of the blade or vane and therefore also of the turbine comprising the blade or vane, since as a whole cooling is more effective and mechanical loading arising, for example, from the impact of foreign bodies only leads to failure of the turbine blade or vane after a relatively long time.

Advantageously, the thermal barrier coating comprises ceramic. In this respect, the inner layer and/or the outer layer can comprise ceramic or consist of ceramic. Ceramic is advantageous on account of its favorable thermally insulating properties.

In principle, the flow ducts of the inner layer can be connected fluidically to the flow ducts of the outer layer. To this end, it is advantageous that at least one flow duct of the inner layer is connected fluidically to at least one flow duct of the outer layer. A fluidic connection of the flow ducts of the inner layer and of the outer layer makes it possible for the cooling fluid, for example the air used for cooling, to flow away effectively, and as a result allows for effective cooling of the turbine blade or vane.

In principle, the turbine blade or vane can comprise a nickel-based superalloy. In this respect, the turbine blade or vane blank or the main body of the turbine blade or vane can consist of a nickel-based superalloy. It is advantageous that the turbine blade or vane comprises a main body with an outer surface. A bonding layer is advantageously arranged between the outer surface of the main body and the inner layer of the thermal barrier coating. The bonding layer allows for suitable bonding of the thermal barrier coating to the base material, for example the nickel-based superalloy. The bonding layer advantageously has a thickness of between 20 μm and 50 μm.

The turbine blade or vane advantageously comprises a main blade or vane part, wherein the thermal barrier coating is arranged on the main blade or vane part. This has the advantage that the main blade or vane part, as the region of the turbine blade or vane which is generally subjected to the greatest thermal loading, can be cooled particularly effectively.

The turbine according to the invention comprises a number of the above-described turbine blades or vanes, i.e. at least one of the above-described turbine blades or vanes. In this respect, the turbine may be a gas turbine or a steam turbine, for example. In principle, the turbine according to the invention has the same properties and advantages as the above-described turbine blade or vane according to the invention.

During the course of the method according to the invention for coating a turbine blade or vane, a thermal barrier coating is applied to at least one partial region of the surface of the turbine blade or vane to be coated. To this end, an inner layer is built up or applied by means of selective laser melting (SLM). The inner layer comprises a number of flow ducts connected fluidically to one another. Furthermore, an outer layer is applied indirectly or directly to the inner layer by means of selective laser melting (SLM). The outer layer comprises a number of flow ducts connected fluidically to one another.

It is advantageous that an intermediate layer is built up on or applied to the inner layer by means of selective laser melting (SLM) and then the outer layer is applied to the intermediate layer.

The described method is suitable for use when producing turbine blades or vanes as new and when refurbishing or reprocessing turbine blades or vanes. It is suitable in particular for producing an above-described turbine blade or vane according to the invention. The turbine blade or vane may be a gas turbine blade or vane or a steam turbine blade or vane, for example. A gas turbine blade or vane or a steam turbine blade or vane can thus be coated during the described coating method.

The described method has the advantage that a two-layer cooling system is generated by means of selective laser melting by the process for producing the coating. If the outer layer becomes damaged, for example by an impact, the cooling system of the turbine blade or vane will be maintained by the inner, second system. This achieves an increase in performance of the turbine blade or vane or the turbine, for example gas turbine, since the turbine blade or vane coated in accordance with the invention can be cooled more effectively than turbine blades or vanes known to date. In particular, less cooling fluid, for example air, is required for cooling.

Moreover, the method according to the invention has the advantage that the laser drilling which is typically required when producing and coating or refurbishing turbine blades or vanes is dispensed with.

It is advantageous that the turbine blade or vane comprises a main blade or vane part and the thermal barrier coating is applied to the surface of the main blade or vane part.

The thermal barrier coating advantageously comprises ceramic. By way of example, the inner layer and/or the intermediate layer and/or the outer layer can thus comprise ceramic. The ceramic material used is in particular yttrium-stabilized zirconium oxide (YSZ) or zirconium oxide at least partially stabilized with yttrium or yttrium oxide.

In principle, outlet openings can be produced between the mutually adjoining layers by means of selective laser melting. By way of example, the inner layer and the outer layer or the inner layer and the intermediate layer or the intermediate layer and the outer layer can thus be connected fluidically to one another via corresponding outlet openings. Furthermore, at least one cooling fluid supply duct can be produced by means of selective laser melting. It is advantageous that separate cooling fluid supply ducts are produced for the inner layer and for the outer layer. This allows for a mutually independent supply of cooling fluid to the inner layer and to the outer layer. In this way, it is possible to influence the temperature gradient in the thermal barrier coating and in the base material in a targeted manner and to avoid stress peaks in the thermal barrier coating (TBC).

It is advantageous that a bonding layer can first be applied to the base material of the turbine blade or vane before the inner layer is applied by means of selective laser melting. The bonding layer can be applied using the thermal spraying method, for example. It is advantageous that a bonding layer having a layer thickness of between 20 μm and 50 μm is applied to the turbine blade or vane to be coated. The bonding layer achieves suitable bonding of the further thermal barrier coating to the base material of the turbine blade or vane. The base material of the turbine blade or vane is a nickel-based superalloy, for example.

The method according to the invention for cooling a turbine blade or vane relates to an above-described turbine blade or vane according to the invention. During the course of the method, cooling fluid is introduced into the flow ducts of the inner layer. In addition, cooling fluid is introduced into the flow ducts of the outer layer. The cooling fluid is air, for example. The cooling method allows for cooling of the blade or vane which is flexible and robust with respect to mechanical loading of the turbine blade or vane, for example by impacts. If, for example, the outer layer becomes damaged, the inner layer continues to allow for cooling of the turbine blade or vane. This simultaneously increases the operating time or the service life of the turbine blades or vanes.

By way of example, cooling fluid can be introduced into the flow ducts of the inner layer through a cooling fluid supply duct connected fluidically only to the inner layer. In addition or as an alternative thereto, cooling fluid can be introduced into the flow ducts of the outer layer through a cooling fluid supply duct connected fluidically only to the outer layer. As a result, the turbine blade or vane is cooled separately and in a mutually independent manner both via the inner layer and via the outer layer.

In addition, cooling fluid which differs from a cooling fluid introduced into the flow ducts of the outer layer in terms of its temperature and/or its composition can be introduced into the flow ducts of the inner layer. This likewise allows for effective and flexible cooling of the turbine blade or vane.

As a whole, the present invention provides a two-layer cooling system generated, for example, by selective laser melting. This makes it possible to realize two-stage cooling in that, for example, mutually independent air streams are established. It is thereby possible to influence the temperature gradient in the thermal barrier coating and in the base material in a targeted manner and to avoid stress peaks in the thermal barrier coating. In this way, the performance of the turbine or of the respective turbine blade or vane is increased by the possibility of more effective cooling. A further advantage of the production of the thermal barrier coating by selective laser melting is that the drilling of the cooling holes is dispensed with.

In principle, firstly an MCrAlX coating can be applied to the base material of the turbine blade or vane before the thermal barrier coating described here is applied. Here, the M in MCrAlX denotes at least one element from the group consisting of iron (Fe), cobalt (Co) and nickel (Ni), and X is an active element and stands for yttrium (Y) and/or silicon and/or at least one rare earth element, or hafnium (Hf).

A turbine blade or vane according to the invention can thus additionally comprise an MCrAlX coating. This is then advantageously arranged between the surface of the main body, for example of the nickel-based superalloy, and the inner layer or the bonding layer of the above-described thermal barrier coating.

### BRIEF DESCRIPTION OF THE DRAWINGS

Further properties, features and advantages of the following invention will be described in more detail hereinbelow on the basis of an exemplary embodiment. The features described in this context are advantageous both individually and also in any desired combination with one another. The exemplary embodiment described does not have a limiting effect on the subject matter of the invention.

FIG. 1 schematically shows a turbine blade or vane in a perspective view and a section through a partial region of the coating.

FIG. 2 schematically shows a gas turbine.

FIG. 3 schematically shows a turbine blade or vane.

### DETAILED DESCRIPTION OF INVENTION

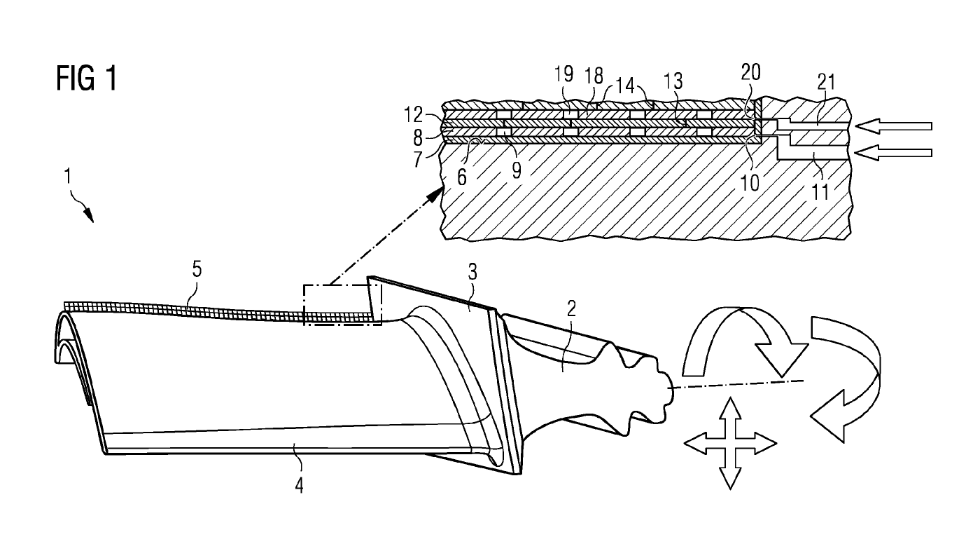

FIG. 1 schematically shows a turbine blade or vane in a perspective view and a section through a partial region of the coating. By way of example, the turbine blade or vane 1 may be a guide vane or a rotor blade of a gas turbine or of a steam turbine.

The turbine blade or vane 1 shown in FIG. 1 comprises a blade or vane root 2, a platform 3 and a main blade or vane part 4. The platform 3 is arranged between the blade or vane root 2 and the main blade or vane part 4. The main blade or vane part 4 is coated with a ceramic thermal barrier coating 5. A section through a partial region of the coating 5 is likewise shown in FIG. 1.

The base material of the turbine blade or vane is in particular a nickel-based superalloy. A bonding layer 7 is advantageously firstly sprayed thermally onto the surface 6 of the turbine blade or vane 1. The bonding layer 7 applied advantageously has a layer thickness of between 20 μm and 50 μm, in order to achieve suitable bonding to the base material.

Furthermore, an inner layer 8 is built up by means of selective laser melting. The inner layer 8 comprises a number of flow ducts 9 connected fluidically to one another. The flow ducts 9 are additionally connected fluidically to a cooling fluid supply opening 10. The supply opening 10 connects the flow ducts 9 of the inner layer 8 to a cooling fluid supply duct 11. Through the cooling fluid supply duct 11, it is possible, for example, for cooling air to be introduced into the inner layer 8 or into the flow ducts 9 of the inner layer 8.

It is either the case that an outer layer 18 is built up directly on or applied directly to the inner layer 8 with the aid of selective laser melting, or firstly an intermediate layer 12 is advantageously built up on the inner layer 8 with the aid of selective laser melting. The intermediate layer 12 advantageously comprises a number of outlet openings 13, which fluidically connect the flow ducts 9 of the inner layer 8 to the flow ducts 19 of the outer layer 18. The outer layer 18 is then built up on or applied to the intermediate layer 12 with the aid of selective laser melting. The outer layer 18 comprises a number of flow ducts 19 connected fluidically to one another. The outer layer 18 furthermore comprises at least one cooling fluid supply opening 20. The cooling fluid supply opening 20 is connected fluidically to a supply duct 21. Through the supply duct 21, it is possible, for example, for cooling air to be introduced into the flow ducts 19 of the outer layer 18. The outer layer 18 can additionally comprise outlet openings 14, which connect the flow ducts 19 of the outer layer 18 to the outer surface of the coated turbine blade or vane 1.

In principle, the inner layer 8, the intermediate layer 12 and the outer layer 18 can be built up generatively by means of selective laser melting. Mutually independent air streams can be established by the thus achieved two-stage cooling system. It is thereby possible to influence the temperature gradient in the thermal barrier coating and in the base material in a targeted manner and to avoid stress peaks in the thermal barrier coating.

The arrows shown in FIG. 1 denote the direction of movement of the turbine blade or vane 1 during the selective laser melting. As an alternative to a corresponding movement of the turbine blade or vane during the selective laser melting, it is in principle also possible for the laser melting apparatus used to be moved in a corresponding manner.

During the course of the method according to the invention for cooling a turbine blade or vane 1, it is possible, for example, for the different supply ducts 11 and 21 to be supplied with cooling fluid, for example air, of a different temperature or different composition. This allows for effective and flexible cooling.

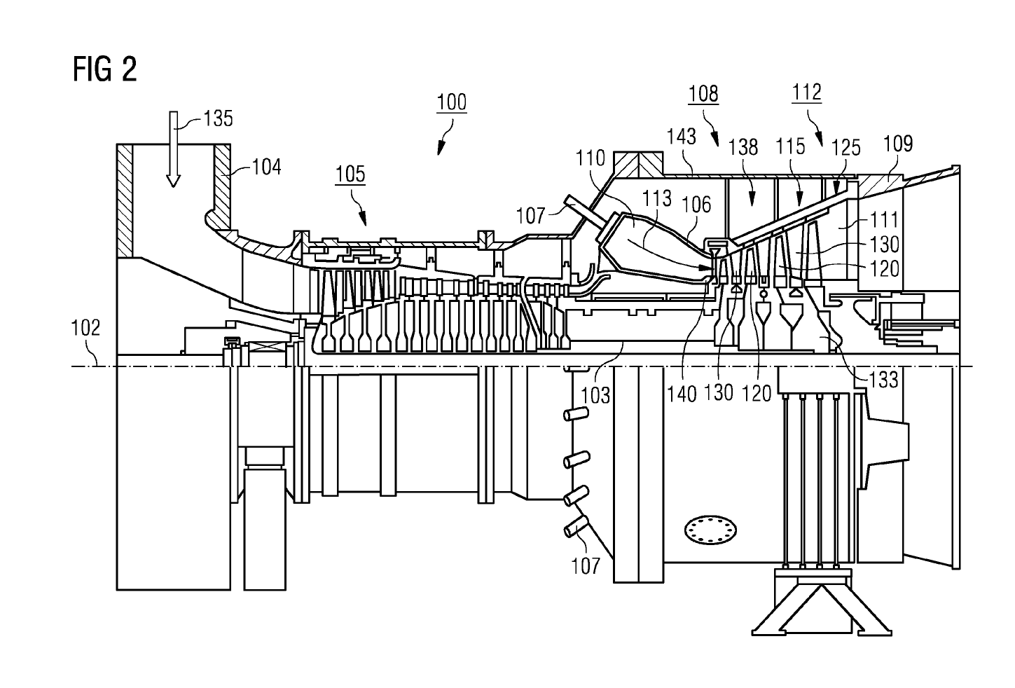

FIG. 2 shows by way of example a partial longitudinal section through a gas turbine 100.

In its interior, the gas turbine 100 has a rotor 103 which is mounted such that it can rotate about an axis of rotation 102, has a shaft 101, and is also referred to as the turbine rotor.

An intake housing 104, a compressor 105, a for example toroidal combustion chamber 110, in particular an annular combustion chamber, with a plurality of coaxially arranged burners 107, a turbine 108 and the exhaust gas housing 109 follow one another along the rotor 103. The annular combustion chamber 110 is in communication with a for example annular hot gas duct 111. There, by way of example, four successive turbine stages 112 form the turbine 108.

Each turbine stage 112 is formed for example from two blade or vane rings. As seen in the direction of flow of a working medium 113, a guide vane row 115 is followed in the hot gas duct 111 by a row 125 formed from rotor blades 120.

The guide vanes 130 are secured in this case to an inner housing 138 of a stator 143, whereas the rotor blades 120 of a row 125 are fitted on the rotor 103, for example by means of a turbine disk 133.

A generator (not shown) is coupled to the rotor 103.

While the gas turbine 100 is operating, air 135 is drawn in through the intake housing 104 and compressed by the compressor 105. The compressed air provided at the turbine end of the compressor 105 is passed to the burners 107, where it is mixed with a fuel. The mixture is then burnt in the combustion chamber 110, forming the working medium 113. From there, the working medium 113 flows along the hot gas duct 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they can be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known for example from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

A thermal barrier coating, consisting for example of ZrO₂, Y₂O₃—ZrO₂, i.e. unstabilized, partially stabilized or fully stabilized by yttrium oxide and/or calcium oxide and/or magnesium oxide, may also be present on the MCrAlX.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

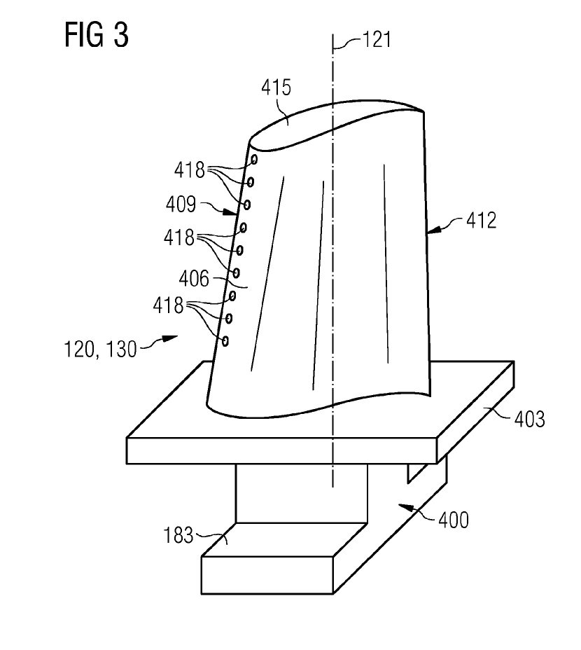

FIG. 3 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, the transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is advantageously 95% of the theoretical density.

A protective aluminum oxide layer (TGO=thermally grown oxide layer) is formed on the MCrAlX layer (as an intermediate layer or as the outermost layer).

The layer advantageously has a composition Co-30Ni-28Cr-8Al-0.6Y-0.7Si or Co-28Ni-24Cr-10Al-0.6Y. In addition to these cobalt-based protective coatings, it is also advantageous to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is advantageously the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are conceivable, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore advantageously more porous than the MCrAlX layer.

Refurbishment means that, after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled in addition to the described cooling according to the invention, it is hollow for example and may also have film-cooling holes 418 (indicated by dashed lines).

1. A turbine blade or vane, comprising: a thermal barrier coating,
wherein the thermal barrier coating comprises an inner layer and an outer layer, which is arranged directly or indirectly on the inner layer, wherein the inner layer comprises flow ducts which are connected fluidically to one another and which are connected to a cooling fluid supply duct,
wherein the outer layer comprises flow ducts which are connected fluidically to one another and which are connected to a cooling fluid supply duct.

2. The turbine blade or vane as claimed in claim 1,
wherein the thermal barrier coating comprises ceramic.

3. The turbine blade or vane as claimed in claim 1,
wherein at least one flow duct of the inner layer is connected fluidically to at least one flow duct of the outer layer.

4. The turbine blade or vane as claimed in claim 1,
wherein the turbine blade or vane comprises a nickel-based superalloy.

5. The turbine blade or vane as claimed in claim 1,
wherein the turbine blade or vane comprises a main body with an outer surface and a bonding layer is arranged between the outer surface of the main body and the inner layer.

6. The turbine blade or vane as claimed in claim 5,
wherein the bonding layer has a thickness of between 20 μm and 50 μm.

7. The turbine blade or vane as claimed in claim 1, further comprising:
a separating layer which is arranged between the inner layer and the outer layer.

8. The turbine blade or vane as claimed in claim 1,
wherein the turbine blade or vane comprises a main blade or vane part and the thermal barrier coating is arranged on the main blade or vane part.

9. A turbine, comprising:
a plurality of turbine blades or vanes as claimed in claim 1.

10. A method for coating a turbine blade or vane, comprising:
applying a thermal barrier coating to at least one partial region of the surface of the turbine blade or vane to be coated,
applying an inner layer, which comprises a number of flow ducts connected fluidically to one another, by selective laser melting, and
applying an outer layer, which comprises a number of flow ducts connected fluidically to one another, indirectly or directly to the inner layer by selective laser melting.

11. The method as claimed in claim 10, further comprising:
applying an intermediate layer to the inner layer by selective laser melting and then applying the outer layer to the intermediate layer.

12. The method as claimed in claim 10, further comprising:
producing outlet openings between the mutually adjoining layers by selective laser melting and/or producing at least one cooling fluid supply duct by selective laser melting.

13. The method as claimed in claim 10,
applying a bonding layer to the base material of the turbine blade or vane before the inner layer is applied by selective laser melting.

14. A method for cooling a turbine blade or vane as claimed in claim 1, comprising:
introducing cooling fluid into the flow ducts of the inner layer and/or introducing cooling fluid into the flow ducts of the outer layer.

15. The method as claimed in claim 14, further comprising:
introducing cooling fluid which differs from a cooling fluid introduced into the flow ducts of the outer layer in terms of its temperature and/or its composition into the flow ducts of the inner layer.
